(19) United States
(12) Patent Application Publication
(10) Pub. No.: US 2015/0203354 A1
(43) Pub. Date: Jul. 23, 2015

(54) METHOD FOR PREPARING NANO-SIZED IRON PHOSPHATE PARTICLES

(71) Applicants: SAMSUNG FINE CHEMICALS CO., LTD, Ulsan (KR); NANOMATERIALS TECHNOLOGY PTE LTD, Singapore (MY)

(72) Inventors: Hyun A Song, Seoul (KR); Dong Gyu Chang, Daejeon (KR); Woo Young Yang, Daejeon (KR); Wei Kian Soh, Singapore (SG); Zhigang Shen, Singapore (SG); Jiyao Zhang, Singapore (SG); Lingyan Gao, Shanghai (CN)

(73) Assignees: SAMSUNG FINE CHEMICALS CO., LTD, Ulsan (KR); NANOMATERIALS TECHNOLOGY PTE LTD, Singapore (MY)

(21) Appl. No.: 14/419,607

(22) PCT Filed: May 13, 2013
(86) PCT No.: PCT/KR2013/004224

§ 371 Date: Feb. 4, 2015

(30) Foreign Application Priority Data
Aug. 10, 2012 (KR) 10-2012-0088047

(51) Int. Cl. C01B 25/37

(52) U.S. Cl. CPC C01B 25/375

(57) ABSTRACT

The present invention relates to a method for preparing nano-sized iron phosphate particles, the method including the steps of: mixing an iron salt solution and a phosphate solution in a reactor in order to prepare a suspension containing amorphous or crystalline iron phosphate precipitate; and applying a shearing force to the mixed solution inside the reactor during the step of mixing, wherein the suspension containing nano-sized iron phosphate precipitate particles is formed by means of the shearing force and the conditions inside the reactor. According to the present invention, micro-mixing takes place faster than nucleation, which provides an advantage for preparing nanoparticles and for preparing particles having a uniform particle size distribution.

### TECHNICAL FIELD

The present invention relates to a method for preparing nano-sized iron phosphate particles.

### BACKGROUND ART

As the technical development and the demand for mobile devices increases, the demand for secondary batteries as an energy source is abruptly increasing. Among such secondary batteries, a lithium secondary battery that has a high energy density and voltage, a long cycle life, and a low self-discharge rate, is commercialized and widely used.

As a positive active material, a lithium-containing cobalt oxide, LiCoO₂, is mainly used. In addition to that, the use of a lithium-containing manganese oxide such as LiMnO₂ with a layered crystal structure and LiMn₂O₄ with a spinel crystal structure, and a lithium-containing nickel oxide LiNiO₂ is also under consideration.

Thus, methods of using lithium transition metal phosphates as the positive active material have been studied in recent years. In particular, since LiFePO₄ has a voltage of about 3.5 V and a high bulk density of 3.6 g/cm³ in comparison with lithium, is a substance having a theoretical capacity of 170 mAh/g and superior high-temperature stability in comparison with a cobalt, Co, and uses low-priced Fe as a raw material, the applicability of LiFePO₄ as a positive active material for a lithium secondary battery is high in the future.

Since crystalline iron(II or III) phosphate (crystalline ferrous or ferric phosphate) is similar in crystal structure to olivine, the synthesis of a high-quality lithium iron phosphate is possible even at a low sintering temperature. As a general method of synthesizing a crystalline iron phosphate, there are a high-priced hydrothermal synthesis method or a method of using a general reactor. When a general reactor is used, it takes a long time to carry out the crystallization step and it is difficult to control a particle size of the product and a P/Fe ratio.

### PRIOR ART DOCUMENT

### Patent Document

Patent Document 1: Korean Unexamined Patent Application Publication No. 2010-0133231
Patent Document 2: Korean Unexamined Patent Application Publication No. 2011-0117552

### DISCLOSURE

### Technical Problem

The present invention is directed to providing a method for preparing nano-sized iron phosphate particles having a uniform particle size distribution.

Also, the present invention is directed to providing a method for preparing nano-sized iron phosphate particles in which particles can be easily controlled, scale up is easy, and the process costs are low.

### Technical Solution

A first embodiment of the present invention provides a method for preparing nano-sized iron phosphate particles, the method including the steps of: mixing an iron salt solution and a phosphate solution in a reactor in order to form a suspension containing amorphous or crystalline iron phosphate precipitates; and applying a shearing force to the mixed solution inside the reactor during the step of mixing, wherein the suspension containing nano-sized iron phosphate precipitate particles is formed by controlling the shearing force and the conditions inside the reactor.

In an embodiment of the present invention, the method may further include a step of isolating the iron phosphate precipitate particles from the suspension.

In an embodiment of the present invention, the method may further include a step of aging the nano-sized iron phosphate precipitate particles.

The step of aging may be carried out under conditions in which crystalline nano-sized iron phosphate precipitate particles are formed.

The iron salt solution may include one or more selected from the group consisting of an iron acetate salt, an iron halide salt, an iron nitrate salt, an iron sulfate salt, an iron hydroxide, and a hydrate and a mixture thereof.

In an embodiment of the present invention, the method may further include a step of selecting the phosphate solution as a precipitation solution.

The phosphate solution may include PO₄³⁻.

The step of applying the shearing force may include stirring the mixed solution with a stirrer.

The stirrer may include a packed bed located inside a sealed chamber, and the packed bed may be rotated about a rotation axis.

The packed bed may have a cylindrical form, and include at least one mesh layer.

By means of the shearing force, flow conditions in which a Reynolds number is 2,000 to 200,000 may be formed inside the reactor.

The nano-sized iron phosphate precipitate particles may have a narrow particle size distribution of which a steepness ratio is smaller than 3.

The mixed solution may further include a surfactant.

The surfactant may include one or more selected from the group consisting of an anionic surfactant, a cationic surfactant, a nonionic surfactant, a polymer surfactant, and a mixture thereof.

A concentration of the surfactant may be 0.05 to 10 wt % based on the mixture.

The mixed solution may further include a dispersant.

A concentration of the dispersant may be 0.05 to 10 wt % based on the mixture.

The nano-sized iron phosphate precipitate particles may be amorphous.

In an embodiment of the present invention, the method may further include a step of aging the suspension under conditions in which crystalline iron phosphate particles are formed.

The step of mixing may be carried out under conditions in which the precipitates mainly containing an iron phosphate are formed.

The conditions may be conditions under which intermediate iron phosphate species are not formed.

The shearing force may be applied under conditions in which at least one of nano-sized amorphous iron phosphate particles and crystalline iron phosphate particles is formed.

A second embodiment of the present invention provides a method for preparing nano-sized crystalline iron phosphate particles, the method including the steps of: mixing an iron salt solution and a phosphate solution under conditions in which nano-sized amorphous iron phosphate particles are formed; and aging the nano-sized amorphous iron phosphate particles under conditions in which nano-sized crystalline iron phosphate particles are substantially formed.

A third embodiment of the present invention provides a method for preparing nano-sized crystalline iron phosphate particles, the method including the steps of: mixing an iron salt solution and a phosphate solution in a reactor under conditions in which nano-sized amorphous iron phosphate particles are formed; applying a shearing force to the mixed solution inside the reactor during the step of mixing, and controlling the shearing force and the conditions inside the reactor to form nano-sized amorphous iron phosphate particles; and aging the nano-sized amorphous iron phosphate particles under conditions in which nano-sized iron phosphate particles are formed.

In an embodiment of the present invention, the method may further include applying a shearing force to a mixture containing nano-sized amorphous iron phosphate particles during the step of aging, and controlling the shearing force and the conditions in the mixture to form the nano-sized iron phosphate particles.

A fourth embodiment of the present invention provides a method for preparing nano-sized crystalline iron phosphate particles, the method including the steps of: mixing an iron salt solution and a phosphate solution in a reactor under conditions in which a mixture containing nano-sized amorphous iron phosphate particles is formed; applying a shearing force to the mixed solution inside the reactor during the step of mixing, and controlling the shearing force and the conditions inside the reactor to form nano-sized amorphous iron phosphate particles; isolating the nano-sized amorphous iron phosphate particles from the mixture containing the nano-sized amorphous iron phosphate particles; aging the nano-sized amorphous iron phosphate particles under conditions in which a mixture containing nano-sized iron phosphate particles is formed; applying a shearing force to the mixture containing the nano-sized amorphous iron phosphate particles during the step of aging, and controlling the shearing force and the conditions inside the mixture to form nano-sized iron phosphate particles; isolating the crystalline iron phosphate particles from the mixture containing the nano-sized iron phosphate particles; and drying the crystalline iron phosphate particles in order to form a crystalline iron phosphate powder.

In any of the first to fourth embodiments of the present invention, the iron salt solution may include one or more selected from the group consisting of an iron (III) acetate salt, an iron(III) halide salt, an iron(III) nitrate salt, an iron(III) sulfate salt, and a hydrate and a mixture thereof.

In any of the first to fourth embodiments of the present invention, the formed iron phosphate precipitate particles may include a ferric phosphate, and the ferric phosphate may include one or more selected from the group consisting of an amorphous ferric phosphate, a crystalline ferric phosphate, and a hydrate and a mixture thereof.

In any of the first to fourth embodiments of the present invention, the iron salt solution may include one or more selected from the group consisting of an iron(II) acetate salt, an iron(II) halide salt, an iron(II) nitrate salt, an iron(II) sulfate salt, an iron(II) hydroxide, and a hydrate and a mixture thereof.

In any of the first to fourth embodiments of the present invention, the formed iron phosphate precipitate particles may include a ferrous phosphate, and the ferrous phosphate may include one or more selected from the group consisting of an amorphous ferrous phosphate, a crystalline ferrous phosphate, and a hydrate and a mixture thereof.

### Advantageous Effects

In a synthesis using high gravity controlled precipitation (HGCP), the raw materials passing through a rotating packed bed are mixed at a molecular level, and thus the reaction occurs instantaneously. Micro-mixing takes place faster than nucleation, and thus it is an advantage for preparing nanoparticles and the particles having a uniform particle size distribution can be prepared. This synthesis method is a bottom up approach, and thus it has an advantage in that particles can be easily controlled, scale up is easy, and the process costs are low.

### DESCRIPTION OF DRAWINGS

FIG. 1 illustrates a schematic diagram of a system for preparing an iron phosphate.

FIG. 2 illustrates an SEM image of amorphous iron phosphate particles prepared according to Example 1 of the present invention.

FIG. 3 illustrates an SEM image of crystalline iron phosphate particles prepared according to Example 2 of the present invention.

FIG. 4 illustrates a primary particle size distribution of the iron phosphate particles prepared according to Example 2 of the present invention.

FIG. 5 illustrates XRD diffraction patterns of the iron phosphate particles prepared according to Example 2 of the present invention.

FIG. 6 illustrates an SEM image of iron phosphate particles prepared according to Example 7 of the present invention.

FIG. 7 illustrates XRD diffraction patterns of the iron phosphate particles prepared according to Example 7 of the present invention.

### MODES OF THE INVENTION

Hereinafter, preferable embodiments of the present invention will be described with reference to the accompanying drawings. The embodiments of the present invention can be modified in many different forms, and the scope of the present invention is not limited to the embodiments disclosed below. Also, the embodiments of the present invention are provided to explain the present invention more fully to those of ordinary skill in the art. Accordingly, shapes, sizes, etc. of the elements in the drawings may be exaggerated for a clearer description, and like reference numbers refer to like elements throughout the various drawings.

A first embodiment of the present invention provides a method for preparing nano-sized iron phosphate particles, the method including: mixing an iron salt solution and a phosphate solution in a reactor in order to form a suspension containing amorphous or crystalline iron phosphate precipitates; and applying a shearing force to the mixed solution inside the reactor during the mixing step, wherein the suspension containing nano-sized precipitate particles is formed by controlling the shearing force and the conditions inside the reactor.

The first embodiment of the present invention relates to a method for preparing nano-sized iron phosphate particles, and the nano-sized iron phosphate particles prepared according to the first embodiment of the present invention may be an amorphous or a crystalline iron phosphate, or an iron phosphate hydrate. Since a crystalline iron phosphate (crystalline ferrous or ferric phosphate) is similar in crystal structure to olivine, the synthesis of a high-quality lithium iron phosphate is possible even at a low sintering temperature. Here, “nano-sized” refers to a size at which an average particle size may be smaller than 1000 nm, particularly smaller than 200 nm, and more particularly 1 to 100 nm.

First, an iron salt solution and a phosphate solution may be prepared.

The iron salt solution means an iron salt dissolved in a solvent, and the solvent may be water as a solvent, an organic solvent (e.g., ethanol), a mixture of water as a solvent and an organic solvent, or a mixture of organic solvents. An anion of the iron salt solution includes one or more selected from the group consisting of halides, sulfates, nitrates, and acetate. A specific example of the anion may include, but is not limited to, one or more selected from the group consisting of Cl⁻, SO₄²⁻, CH₃COO⁻, NO₃⁻, and OH⁻.

The iron salt may be a compound including at least one anion and at least one cation. The cation and the anion in the iron salt may be a mono-ion (a monoatomic ion) such as Fe²⁺, Fe³⁺, or Cl⁻ or a composite ion (a polyatomic ion) such as CH₃COO⁻, NO₃²⁻, SO₄²⁻, or OH⁻. At least one of cations in the iron salt may be Fe³⁺ or Fe²⁺. The iron salt is not particularly limited as long as it can be completely or partially dissolved in a selected solvent, but a desirable example of the iron salt may be selected from an iron acetate salt, an iron halide salt, an iron nitrate salt, an iron sulfate salt, an iron hydroxide salt, and a hydrate and a mixture thereof.

The phosphate solution means a solution in which a solute containing PO₄³⁻ is dissolved in a solvent, and when the phosphate solution is added to the iron salt solution, precipitate particles may be formed or grow. The phosphate solution may be prepared by dissolving a solid salt including a phosphate salt in a solvent, and the solvent may include water, an organic liquid (e.g., alcohol), or a mixture thereof. An anion in the phosphate salt may include one or more selected from the group consisting of HPO₄²⁻, H₂PO⁴⁻, PO₄³⁻, and a hydrate and a mixture thereof. However, at least one of anions in the phosphate salt may be PO₄³⁻.

Thereafter, the iron salt solution and the phosphate solution may be mixed in a reactor. When the iron salt solution and the phosphate solution are mixed, iron ions in the iron salt solution may react with phosphate ions in the phosphate solution to form iron phosphate precipitate particles. The precipitated iron phosphate particles may be evenly dispersed in the mixed solution to form a suspension.

In the embodiment of the present invention, the step of mixing of the iron salt solution and the phosphate solution may be carried out under conditions in which at least one of nano-sized amorphous iron phosphate particles and crystalline iron phosphate particles is precipitated. That is, when the iron salt solution and the phosphate solution are mixed, nano-sized amorphous iron phosphate particles may be precipitated, nano-sized crystalline iron phosphate particles may be precipitated, or nano-sized amorphous iron phosphate particles and nano-sized crystalline iron phosphate particles may be precipitated together.

A reactor means a region in which the iron salt solution reacts with the phosphate solution to form the iron phosphate. This will be described in detail in the section regarding the molecular level mixing unit and the preparing system.

Thereafter, a shearing force may be applied to the mixed solution inside the reactor during the mixing step.

When the shearing force is applied to the mixed solution, the precipitated nano-sized iron phosphate particles may have a relatively narrow particle size distribution. Breadth of the particle size distribution may be represented as a steepness ratio. The steepness ratio may be defined as the value obtained by dividing the average diameter of the particles corresponding to 75 wt % by the average diameter of the particles corresponding to 25 mass %. If the steepness ratio is large, the particle size distribution curve is wide. If the steepness ratio is small, the particle size distribution curve is narrow and may represent a sharper shape. The particle size distribution may be represented by a SediGraph. The SediGraph plots a cumulative mass percent versus a particle size. The cumulative mass percent means the percent (by mass) occupied by particles of which a particle size is equal to or smaller than a specific value. An average particle size is the same as the size of the precipitate particles at the 50% point on the SediGraph. In the embodiment of the present invention, the steepness ratio may be less than 3. Preferably, the steepness ratio may be less than 2, 1.9, 1.8, 1.7, 1.6, or 1.5, more preferably, the steepness ratio may be less than 1.3.

The shearing force may be generated by stirring the mixed solution inside the reactor with a stirrer, and the stirrer will be described in detail in the following corresponding section. When the shearing force is applied to the reactor, a fluid flow with a Reynolds number of 2,000 to 200,000, 5,000 to 150,000, or 8,000 to 100,000 may be formed inside the reactor. Thus, substances inside the reactor may be readily mixed, and a substantially homogeneous mixture may be formed.

An average particle size of the nano-sized amorphous or crystalline iron phosphate precipitate particles formed according to the embodiment of the present invention may be 1 to 100 nm, preferably 1 to 20 nm, 5 to 30 nm, 5 to 50 nm, 10 to 20 nm, 10 to 50 nm, 20 to 50 nm, 15 to 30 nm, 10 to 100 nm, 10 to 60 nm, or 15 to 20 nm.

In the embodiment of the present invention, a surfactant may also be added to the mixed solution. The surfactant may be selected from the group consisting of an anionic surfactant, a cationic surfactant, a nonionic surfactant, a polymer surfactant, and a mixture thereof. Specifically, the surfactant may be selected from the group consisting of ammonium dodecyl-sulfate, ammonium lauryl sulfate, ammonium laurate, dioctyl sodium sulphosuccinate, TWEEN® (polyethylene sorbitan monooleate), SPAN 80® (sorbitan monooleate), SPAN 85® (sorbitan trioleate), PLURONIC® (Ethylene Oxide/Propylene Oxide block copolymer), polyoxyethylene fatty acid esters, poly(vinylpyrrolidone), polyoxyethylene alcohols, polyethylene glycol, monodiglyceride, benzalkonium chloride, bis-2-hydroxyethyl oleyl amine, hydroxypropyl cellulose, hydroxypropyl methylcellulose, quarternary ammonium salts such as cetyltrimethylammonium bromide, polymers with positively charged functional groups in the backbone, and a mixture thereof. A concentration of the surfactant may be 0.05 to 10 wt % based on the mixture. If the concentration of the surfactant is less than 0.05 wt %, there is a problem in that the surfactant may not fulfill its own function. If the concentration of the surfactant is larger than 10 wt %, there is a problem in that the surfactant may interfere with the formation of the product. Preferably, the concentration of the surfactant may be 0.05 to 5 wt %, 0.05 to 1 wt %, 0.05 to 0.5 wt %, 0.05 to 0.1 wt %, 0.1 to 10 wt %, 0.5 to 10 wt %, 1 to 10 wt %, 5 to 10 wt %, or 0.1 to 2 wt %.

In the embodiment of the present invention, a dispersant may be added to the mixed solution in order to suppress the agglomeration of the precipitate particles. The dispersant may be added during the mixing step. The dispersant may be an organic solvent, and may be used by mixing with water. The dispersant may be selected from the group consisting of imidazoline, oleyl alcohol, and ammonium citrate. The dispersants suitable for micro-sized or nano-sized particles are disclosed in Organic Additives And Ceramic Processing, by D. J. Shanefield, Kluwer Academic Publishing, Boston, 1996. In particular, since the nano-sized precipitate particles may be present in a dispersed state, the nano-sized precipitate particles are stable, and may not generally form agglomerates over a considerable period of time, and thus the properties of the particles are not changed even if time has elapsed. The concentration of the dispersant may be about 0.05 to 10 wt % based on the mixture. If the concentration of the dispersant is less than 0.05 wt %, there is a problem in that the product may be agglomerated. If the concentration of the dispersant is larger than 10 wt %, there is a problem in that the dispersant may interfere with the formation of the product.

In the embodiment of the present invention, a gas may be injected into the reactor while a shearing force is applied. Specifically, the gas may be oxygen, ammonia gas, air, or an inert gas such as nitrogen. If an oxidizing atmosphere is required, air or oxygen may be injected, if a reducing atmosphere is required, ammonia gas may be injected, and if an inert atmosphere is required, an inert gas such as nitrogen may be injected.

In the embodiment of the present invention, the nano-sized iron phosphate precipitate particles may be amorphous.

In the embodiment of the present invention, the method may further include a step of aging the suspension under conditions in which crystalline iron phosphate particles are formed. The step of aging may be a process in which suspension of precipitate particles is maintained for a certain time under certain conditions (temperature, pressure, pH, and stirring speed) so that the precipitate particles have a substantially crystalline structure. The crystalline structure of the precipitate particles may be formed by the rapid nucleation or partial melting and re-crystallization of the precipitate particles, as melted particles re-crystallize on un-melted particles to form complete crystalline particles or larger precipitate particles. Chemical aging may mean a process in which chemical substances such as acids or bases are added to the reaction mixture during the aging process in order to facilitate the aging process.

The conditions under which crystalline ferric phosphate particles are formed from nano-sized amorphous ferric phosphate particles, for example, may include the following processes (1), (2), and (3). (1) The suspension of the precipitate particles is heated by gradually raising the temperature while stirring the suspension constantly (e.g., the suspension is heated from 25° C. to about 95° C. at a constant speed while stirring constantly); (2) pH of the suspension is maintained in an appropriate range (e.g., about 3 to 5 or 2 to 4 of pH) for about 1 to 5 hours at about 95° C.; and (3) The suspension is cooled down to room temperature (i.e., 25° C.). Here, the saturation amount of solvent may be varied by means of the heating step (1), which may result in enhancing the re-crystallization or Ostwald ripening phenomenon. Then, the precipitate particles may grow or re-crystallize to form the particles having the crystalline structure or the particles having a larger size.

In the embodiment of the present invention, a gas may be injected into the suspension during the aging step. Specifically, the gas may be oxygen, ammonia gas, air, or an inert gas such as nitrogen. If an oxidizing atmosphere is required, air or oxygen may be injected, if a reducing atmosphere is required, ammonia gas may be injected, and if an inert atmosphere is required, an inert gas such as nitrogen may be injected.

In the embodiment of the present invention, mixing of the iron salt solution and phosphate solution may be carried out under conditions in which precipitates containing iron phosphate are formed. Formation of intermediate iron phosphate species may be suppressed under these conditions. The intermediate iron phosphate species may include iron salts, and metal hydroxide oxide compounds formed during the precipitation process of the precipitation solution. For example, if the pH value of the precipitation solution is greater than 7, hydroxyl ions (OH⁻) may react with iron salts (i.e., iron cations (Fe³⁺, Fe²⁺) of iron chloride (FeCl₃, FeCl₂)) inside the solution to form precipitates immediately. The precipitates may not be present in a single phase of iron hydroxide or iron oxide but may be present in a combination of a hydroxide and an oxide. When the intermediate species is heated during the sintering or aging step, the reaction may further proceed to form complete iron oxide crystals, or when bubbling occurs in the intermediate species due to the air or oxygen, the reaction may further proceed to form Fe₂O₃ particles. However, it is more preferable that the intermediate species not be formed, and the cations (Fe³⁺, Fe²⁺) react directly with phosphate ions (PO₄³⁻) to form iron phosphate.

In the embodiment of the present invention, the shearing force may be applied under conditions in which at least one of nano-sized amorphous iron phosphate particles and crystalline iron phosphate particles is formed.

In the embodiment of the present invention, the method may include (a) a step of providing iron salts in order to prepare an iron salt solution; (b) a step of providing a phosphate solution selected from the group consisting of salts containing HPO₄²⁻, H₂PO₄⁻, PO₄³⁻, and a mixture thereof; (c) a step of mixing the iron salt solution and the phosphate solution in order to form a reaction mixture, wherein the step of mixing is carried out under conditions for forming the suspension of nano-sized amorphous iron phosphate precipitate particles; (d) a step of isolating amorphous iron phosphate particles from the suspension in order to obtain iron phosphate particles; (e) a step of aging the nano-sized amorphous iron phosphate particles in order to form nano-sized crystalline iron phosphate particles; and (f) a step of isolating the crystalline iron phosphate particles from the suspension in order to obtain the nano-sized crystalline ferric phosphate particles substantially free of by-products.

The aging step (e) may be chemical aging that involves the addition of chemical substances such as acids or bases in order to facilitate the aging process. The aging step (e) may be carried out under conditions in which crystalline iron phosphate particles are formed from the formed nano-sized amorphous iron phosphate particles.

The conditions may include, for example, the following processes. (1) The suspension of the precipitate particles is heated by gradually raising the temperature while stirring the suspension constantly (e.g., the suspension was heated from 25° C. to about 95° C. at a constant speed while stirring constantly); (2) a pH of the suspension is maintained in an appropriate range (e.g., a pH of about 3 to 5 or 2 to 4) for about 1 to 5 hours at about 95° C.; and (3) the suspension is cooled down to room temperature (i.e., 25° C.).

The solubility (degree of saturation) of the solvent may be varied by means of the heating step (1), which may result in enhancing the re-crystallization or Ostwald ripening phenomenon. Then, the precipitate particles may grow or re-crystallize to form the particles having the crystalline structure or the particles having a larger size.

A second embodiment of the present invention provides a method for preparing nano-sized crystalline iron phosphate particles, the method including the steps of: mixing an iron salt solution and a phosphate solution under conditions in which nano-sized amorphous iron phosphate particles are formed; and aging the nano-sized amorphous iron phosphate particles under conditions in which nano-sized crystalline iron phosphate particles are substantially formed.

The second embodiment of the present invention relates to a method for preparing nano-sized crystalline iron phosphate particles.

“Substantially” does not exclude “completely.” For example, a composition substantially free of Y may also include a composition including no Y at all (completely free). The terms used in the second embodiment of the present invention are the same as described in the first embodiment of the present invention.

A third embodiment of the present invention provides a method for preparing nano-sized crystalline iron phosphate particles, the method including the steps of: mixing an iron salt solution and a phosphate solution in a reactor under conditions in which nano-sized amorphous iron phosphate particles are formed; applying a shearing force to the mixed solution inside the reactor during the mixing step, and controlling the shearing force and the conditions inside the reactor to form nano-sized amorphous iron phosphate particles; and aging the nano-sized amorphous iron phosphate particles under conditions in which nano-sized iron phosphate particles are formed.

In the third embodiment of the present invention, the method may further include a step of applying a shearing force to a mixture containing nano-sized amorphous iron phosphate particles during the aging step, and a step of controlling the shearing force and the conditions inside the mixture to form the nano-sized iron phosphate particles.

A fourth embodiment of the present invention provides a method for preparing nano-sized crystalline iron phosphate particles, the method including the steps of: mixing an iron salt solution and a phosphate solution in a reactor under conditions in which a mixture containing nano-sized amorphous iron phosphate particles is formed; applying a shearing force to the mixed solution inside the reactor during the mixing step, and controlling the shearing force and the conditions inside the reactor to form nano-sized amorphous iron phosphate particles; isolating the nano-sized amorphous iron phosphate particles from the mixture containing the nano-sized amorphous iron phosphate particles; aging the nano-sized amorphous iron phosphate particles under conditions in which a mixture containing nano-sized iron phosphate particles is formed, applying a shearing force to the mixture containing the nano-sized amorphous iron phosphate particles during the aging step, and controlling the shearing force and the conditions inside the mixture to form nano-sized iron phosphate particles; isolating the crystalline iron phosphate particles from the mixture containing the nano-sized iron phosphate particles; and drying the crystalline iron phosphate particles in order to form a crystalline iron phosphate powder.

The reaction mixture may be the solution including the mixture of the iron salt solution and the phosphate solution, in which the iron salt solution and the phosphate solution may react with each other to form precipitate particles, or the precipitate particles may already be formed by the reaction.

Term “isolating” or “isolation” means a process associated with removing the precipitate particles from the reaction medium. For example, it may include filtration, centrifugation, spray drying, freeze-drying, or another known method for removing a solid from another liquid. However, as the reaction medium may remain on the precipitate particles even after the isolation step, the isolation does not necessarily mean that the precipitated particles are completely removed from the reaction medium. However, the isolation may include cases in which the reaction medium is completely removed from the particles.

In each of the embodiments of the present invention, the iron salt solution may include one or more selected from the group consisting of an iron(III) acetate salt, an iron(III) halide salt, an iron(III) nitrate salt, an iron(III) sulfate salt, and a hydrate or a mixture thereof. The formed iron phosphate precipitate particles may include a ferric phosphate, and the ferric phosphate may include one or more selected from the group consisting of an amorphous ferric phosphate, a crystalline ferric phosphate, and a hydrate or a mixture thereof.

In each of the embodiments of the present invention, the iron salt solution may include one or more selected from the group consisting of an iron(II) acetate salt, an iron(II) halide salt, an iron(II) nitrate salt, an iron(II) sulfate salt, an iron(II) hydroxide, and a hydrate and a mixture thereof.

The formed iron phosphate precipitate particles may include a ferrous phosphate, and the ferrous phosphate may include one or more selected from the group consisting of an amorphous ferrous phosphate, a crystalline ferrous phosphate, and a hydrate and a mixture thereof.

Molecular Level Mixing Unit

The reactor may be located inside a sealed chamber of a molecular level mixing unit.

The molecular level mixing unit may include a stirrer inside the sealed chamber. The molecular level mixing unit may include at least two fluid inlets for introducing a fluid into the sealed chamber, and optionally, may further include an outlet for removing suspended precipitates from the chamber.

By use of a stirrer, a high shearing force may be applied to the reaction mixture, and the solutions may be appropriately and uniformly mixed in a very short time (less than 10 s, preferably less than 1 s, more preferably less than 10 ms), thereby preparing precipitates having a desired size.

The reaction mixture may be the solution including the mixture of the iron salt solution and the phosphate solution, in which the iron salt solution and the phosphate solution may react with each other to form precipitate particles, or the precipitate particles may already be formed by the reaction.

The molecular level mixing unit may be operated in the turbulent flow state in order to fulfill micro-mixing requirements of the reactant, apply a high shearing force to the reaction mixture, and mechanically mix the two solutions in a very short time. The two solutions may be mixed faster by means of the turbulent flow.

A Reynolds number may be controlled based on the following formula.

$$Re = \frac{d \cdot u \cdot ρ}{μ}$$

Here, d is the diameter of the pipe (or the distributor) for supplying the reaction solution to the molecular level mixing unit, u is the velocity of the liquid, ρ is the density of the liquid, and μ is the viscosity of the liquid.

The relationship between the diameter, velocity, and flux of the pipe or distributor is based on the following formula.

$$Q = \frac{π \cdot {d}^{2} \cdot u}{4}$$

Here, Q is the flux.

Once the diameter of the pipe or distributor is determined, the velocity is determined by the flux. A pressure is required in order to maintain the jet flux. Accordingly, the diameter, flux, pressure, and Reynolds number are associated parameters.

The jet flux is preferably 0.1 to 3,000 m³/hr, and more preferably 0.1 to 800 m³/hr. The jet pressure is preferably 30 to 3,000 kg/cm², and more preferably 50 to 1,000 kg/cm². The Reynolds number Re of the jet flow is preferably 2,000 to 200,000, and more preferably 8,000 to 100,000.

If the Reynolds number is in the above range, in the reactor, it is possible to obtain chemical homogeneity of the molecular level before the nucleation. For this reason, since it is possible to obtain a high super-saturation state in a short time, a number of nuclei can be generated in the first precipitation stage, thereby preparing fine precipitate particles having a uniform particle size distribution.

Since it is possible to obtain chemical homogeneity of the molecular level in the reactor in a very short time, in the synthesis of iron phosphate, the formation of larger intermediate agglomerates, and the formation of the intermediate species such as iron hydroxides, hydrous ferric oxides and ferrous oxides, or amorphous ferric oxyhydroxides may be suppressed. Thereby, the precipitates may consist mainly of iron phosphate.

A stirrer may include a rotor and a stator located inside the sealed chamber. The rotor can be rotated about a rotation axis, and thus it is possible to apply a high shearing force to the reaction mixture. The stirrer including the rotor and the stator located inside the sealed chamber is disclosed in U.S. Pat. No. 6,458,335.

The stirrer may include a packed bed located inside the sealed chamber. The packed bed may be rotated about a rotation axis, and thus it is possible to apply a shearing force to the mixture. The packed bed may have a specific surface area of 100 to 3,000 m²/m³. The packed bed may have a regular structure, or may not have a regular structure. The packed bed may be a wire mesh type made of a relatively inert material such as stainless steel, a general metal alloy, the metal titanium or a plastic. The packed bed may have a substantially cylindrical form, and may have at least one mesh layer. The packed bed may have a plurality of overlapping mesh layers. By use of shear means, a shearing force may be applied to the mixed solution. The shear means may be a cylindrical shaped roll mesh form, and a cylindrical shaped portion may have a side surface formed by a plurality of overlapping mesh layers. A mesh size may be 0.05 to 3 mm or 0.1 to 0.5 mm. Mesh porosity may be larger than at least 90% or 95%. The packed bed is mounted on the shaft inside the reactor, and may be rotated inside the reactor. While the packed bed is rotated, the packed bed may apply a high shearing force to the injected liquid. In one example, the rotating packed bed may have a cylindrical form.

By rapidly rotating the stirrer inside the reactor, it is possible to obtain a high gravity level gr (m/s²) sufficient to apply a high shearing force to the liquid inside the reactor. Thereby, micro-mixing requirements may be fulfilled in a very short time.

The high gravity level may be controlled according to the following formula.

$$g = {( 2 IC N \text{/} 60 )}^{2} \frac{{d}_{in} + {d}_{out}}{2}$$

Here, N is the rotational speed (rpm) of the stirrer, dᵢₙ is the internal diameter of the stirrer, and dₒᵤₜ is the external diameter of the stirrer.

The high gravity level may be 100 to 15,000 m/s², 500 to 2,000 m/s², 1,000 to 5,000 m/s², or 800 to 5,000 m/s². Since the stirrer of a strong high gravity level is used, a strong shearing force may be applied to the liquid inside the reactor as soon as it is injected into the reactor.

In one example, when the stirrer is rotated inside the reactor, the iron salt solution and the phosphate solution may be injected into the empty space formed by the vortex. Preferably, a liquid may be injected directly onto the stirrer, and the injection speed may be at least 1 m/s, at least 2 m/s, at least 3 m/s, at least 4 m/s, or at least 5 m/s.

The vortex should be interpreted broadly to include a spiral motion of the reaction mixture inside the reactor. The spiral motion of the reaction mixture tends to move the reaction mixture to the center thereof. Generation of the vortex may depend on a stirring speed inside the chamber, viscosity of the reaction mixture, and the shape and dimensions of the chamber. The reactor may be defined by the shape and dimensions of the chamber. Mathematical models for vortex formation of an incompressible fluid are already known. For example, Transport Phenomena, Bird et al., Chapter 3, John Wiley & Sons, 1960 includes a general discussion about the flow of vortex fluids, and in particular, pages 108 to 111 disclose a mathematical model for the prediction of the depth of a vortex in a stirred tank. The vortex in a stirred tank has been studied experimentally in literature including Memoirs of the Faculty of Engineering, Kyoto University, Vol. XVII, No. III, July 1955 by S Nagata et al.

The iron salt solution and phosphate solution may be injected into the reactor through a plurality of inlets extending through the reaction chamber surrounding the reactor. The inlet may be disposed in various ways depending on the structure of the molecular level mixing unit.

The inlet may be located inside the distributor. The distributor may distribute the iron salt solution and phosphate solution into the empty space formed by the vortex inside the reactor. The distributor may include a body having a plurality of inlets for each of the iron salt solution and the phosphate solution.

The iron salt solution and phosphate solution may be alternately jetted from the holes of the distributor. It is preferable that the inlets protrude into the inner edge of the stirrer at which the shearing force is generated.

In one example, the iron salt solution and phosphate solution may each be injected into the reactor through a separate inlet.

When a molecular level mixing unit is operated in a batch mode or a continuous mode, the mixing unit may include at least one liquid outlet for extracting the mixture from the reactor.

System for Preparing Precipitate Particles

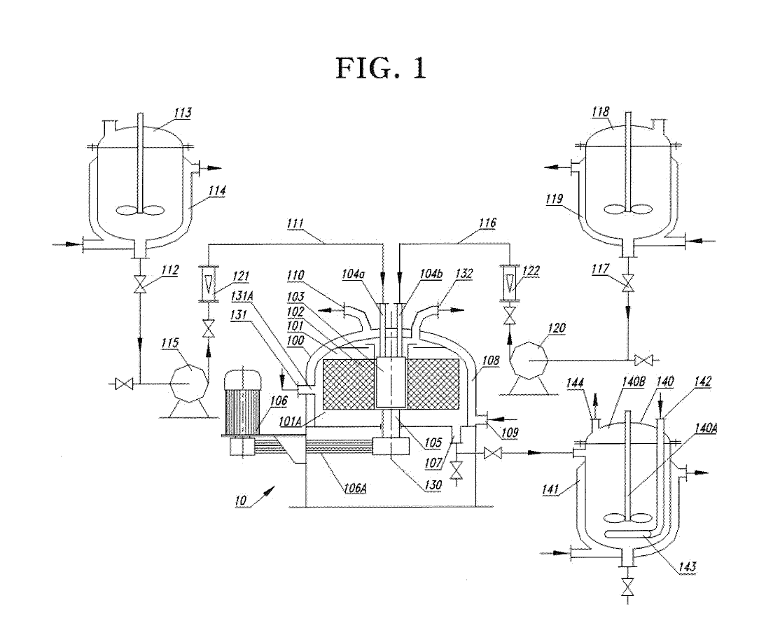

FIG. 1 illustrates a system 10 for preparing nano-sized iron phosphate precipitate particles.

Referring to FIG. 1, the system may include a molecular level mixing unit 100. The molecular level mixing unit 100 may include a chamber 101 surrounding a sealed space, and the sealed space may be defined by a reactor 101A in which the reaction of an iron salt solution and a phosphate solution takes place. The chamber 101 may include a stirrer having a form of a packed bed 102. The packed bed 102 may apply a shearing force to the reaction mixture inside the reactor 101A. The packed bed 102 may include a distributor 103 having two liquid inlets 104a and 104b for supplying the iron salt solution and the phosphate solution respectively to the reactor 101A.

The packed bed 102 may be mounted on a rotation shaft 105 located on the axis of rotation represented by a line 130. The packed bed 102 may be mounted close to the length of the distributor 103. The packed bed 102 may be driven through a gear and pulley system 106A by a motor 106. The motor 106 may rotate the shaft 105 about the axis of rotation 130.

The packed bed 102 is connected to the distributor 103 so that the fluid may move. The distributor 103 may include a body having the flow path capable of transferring the liquid on the packed bed 102. The distributor 103 is connected to the inlet flows 104a and 104b so that the fluid may move, and the inlet flows 104a and 104b are each connected to an iron salt solution feed tank 113 and a phosphate solution feed tank 118 so that the fluid may move.

The molecular level mixing unit 100 may include an outlet flow 107 for removing the suspension containing the precipitate particles from the chamber 101. The material of the molecular level mixing unit may be titanium and alloys thereof.

The packed bed 102 may have a substantially cylindrical shape, may be arranged in a specific structure, and may include a plurality of wire mesh layers having a mesh size of 0.05 mm. The wire mesh may also be made of titanium.

A heat insulating jacket 108 may surround the chamber 101 to control the temperature of the reactor 101A. The heat insulating jacket 108 may include a jacket inlet 109 for the inflow of the heated fluid and a jacket outlet 110 for the outflow of the fluid from the jacket 108.

The inlet flow 104a may be connected by a pipe 111 and a valve 112 to the iron salt solution feed tank 113 in which the iron salt solution is stored. The heat insulating jacket 114 may surround the tank 113 to control the temperature of the iron salt solution inside the tank 113. A pump 115 disposed along the pipe 111 may pump the iron salt solution from the feed tank 113 to the reactor 101A of the molecular level mixing unit 100.

The inlet flow 104b may be connected by a pipe 116 and a valve 117 to the phosphate solution feed tank 118 in which the phosphate solution is stored. The heat insulating jacket 119 may surround the tank 118 to control the temperature inside the tank 118. A pump 120 may be disposed along the pipe 116 in order to supply the phosphate solution the feed tank 118 to the reactor 101A of the molecular level mixing unit 100.

A pair of flowmeters 121 and 122 may be disposed along the pipes 111 and 116 in order to control the flow rates of the iron salt solution and phosphate solution respectively to the inlet flows 104a and 104b.

An outer shell of the molecular level mixing unit of FIG. 1 may include a gas zone 131A over the reactor 101A, wherein the gas zone 131A may contain an inert gas such as nitrogen, air, or concentrated oxygen. The gas zone 131A may be formed by pumping a gas through a gas inlet 131 into the chamber 101, and the gas may be removed through a gas outlet 132.

If it is desired to block oxygen from the reactor 101A, the gas zone 131A may be filled with nitrogen. If it is desired for oxygen to come in contact with the reactor 101A, the gas zone 131A may be filled with air or concentrated oxygen, thereby improving gas-liquid mass transfer. For this reason, the gas zone 131A may function as a barrier for blocking oxygen from the reactor 101A, and also function as a gas purge for bringing air or oxygen in contact with the reaction mixture.

The distributor 103 may jet the iron salt solution and the phosphate solution from the liquid inlets 104a and 104b to the inner surface of the packed bed, and the iron salt solution and the phosphate solution may be mixed and react with each other to form a mixture inside the packed bed 102 and the chamber 101. The mixture may move through the packed bed 102 in a radial direction to the outer surface of the packed bed.

In the packed bed, since the shaft 105 and the packed bed 102 rotate about the axis of rotation 130, a high shearing force in the centrifugal force type may be applied to the mixture.

Then, the mixture inside the packed bed 102 is spread or split under the high gravity field formed by the centrifugal force and becomes micrometer- to nanometer-sized threads of very fine droplets or thin films, and thus active mass transfer and heat transfer may be realized between the iron salt solution and the phosphate solution. This may also cause intense micro-mixing between the iron salt solution and the phosphate solution to form a highly uniform supersaturated solution in a very short time (less than 10 ms). While this varies depending on what phosphate solution is used, the precipitates of the nano-sized iron phosphate compound in the process may be formed.

The size of the centrifugal force acting on the mixture inside the packed bed 102 may vary depending on the rotational speed of the shaft 105 and the packed bed 102. The higher the rotational speeds of the shaft 105 and the packed bed 102, the greater the high gravity level or the shearing force applied to the mixture.

The nano-sized iron phosphate particles which are suspended in the mixture may be removed from the chamber 101 through the product outlet 107. The suspension of the nano-sized iron phosphate particles may be collected in the product tank 140.

The product tank 140 may include a gas blanket 140B over the slurry in which the precipitate particles are suspended. The gas blanket 140B may be formed by a gas distributor 143 connected by a gas outlet 144 and a gas inlet 142 in the bottom of the tank, and may isolate the aging or post-treatment process using nitrogen as the inert protective gas from the oxygen environment, or may enhance the oxidation reaction of the precipitates by enhancing the gas-liquid mass transfer.

The temperature of the precipitate slurry suspension may be increased gradually up to a certain temperature through a heat insulating jacket 141. The suspension may also be stirred continuously through the stirrer. At the same time, the suspension may be neutralized using acids or bases, and may be maintained at the set pH value. After that, the precipitate suspension may be isolated and washed in order to obtain nano-sized iron phosphate particles.

Hereinafter, the present invention will be described in greater detail with reference to Examples.

The particle size of iron phosphate was measured using Hitachi S-4200 FE-SEM (15 kV). The iron phosphate was ground to make a fine powder, and this was loaded on a carbon tape and sputtered on a gold thin film to prepare a scanning electron microscopic specimen. The particle size was measured at a magnification of 80,000 to 150,000 times through a scanning electron microscope (SEM) and the software ImageJ. The particle size distribution was based on the particle size measurement data of ImageJ using the software Microsoft Excel.

The crystal structure was identified through a CuKα X-ray diffraction (Shimadzu XRD-6000 Powder Diffractometer). The powder obtained by drying the suspension of the iron phosphate in an oven at 70° C. and grinding it was pressed in an aluminum plate to prepare a sample for analysis.

In the following Examples, the iron phosphate particles were prepared using the system 10 of FIG. 1.

### EXAMPLE 1

### Synthesis of Amorphous Iron(III) Phosphate (Ferric Phosphate) (FePO₄.2H₂O)

Iron chloride (FeCl₃) was dissolved in distilled water and 2.52 l of the iron chloride solution having a concentration of 0.32 mol/l was filtered, and stored in the iron salt tank 113. Diammonium phosphate ((NH₄)₂HPO₄) was dissolved in distilled water and 2.52 l of the diammonium phosphate ((NH₄)₂HPO₄) solution having a concentration of 0.32 mol/l was filtered, and stored in the tank 118. The iron chloride solution and the diammonium phosphate ((NH₄)₂HPO₄) solution were each pumped through a distributor 103 into the reactor 101A of the molecular level mixing unit at a velocity of 0.4 l/min at the same time. The reactants were maintained at room temperature (25° C.) during the mixing and reaction steps. At this time, the high gravity level of the packed bed 102 was set to 1579 m/s², and the injection speed of the two solutions was set to 5 m/s. The residence time in the molecular level mixing unit was set to 20 s. The suspension in which yellow precipitates were suspended was collected in the product tank 104, an ammonium hydroxide solution (5.82 wt %) was added thereto, and the mixture was stirred for 15 min under atmospheric conditions. After isolation by centrifugation and washing, the mixture was dried for 16 hours at 70° C. to prepare the amorphous ferric phosphate nanoparticles. According to the outcomes of the XRD pattern and the SEM analysis of FIG. 2 for the sample prepared according to the present Example, the amorphous spherical ferric phosphate nanoparticles were obtained, the average particle size thereof was 15 nm, and the steepness ratio was 1.42.

### EXAMPLE 2

### Synthesis of Crystalline Iron(III) Phosphate (Ferric Phosphate) (FePO₄.2H₂O)

The amorphous ferric phosphate particles were dispersed in water to prepare the amorphous ferric phosphate suspension having a pH of 3.7. The temperature of the slurry suspension inside the tank 140 was varied from 25° C. to 95° C. The pH value was maintained at 2.41 by adding phosphoric acid (H₃PO₄) at a concentration of 85%. The tank 140 was stirred vigorously in order to prevent the settling of the particles and facilitate the heat transfer while the temperature was changed. After being treated for 90 min at 95° C., the yellow suspension changed the tank 140 to a pink-white color. The pink-white iron phosphate particles were centrifugated and washed so that the pH value of the supernatant was 3.27.

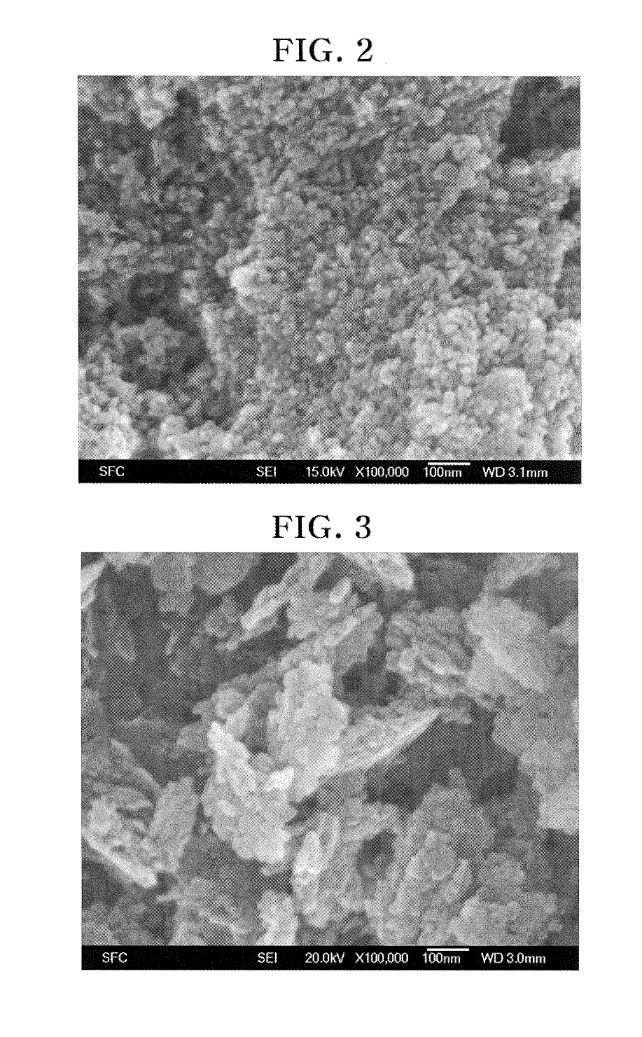

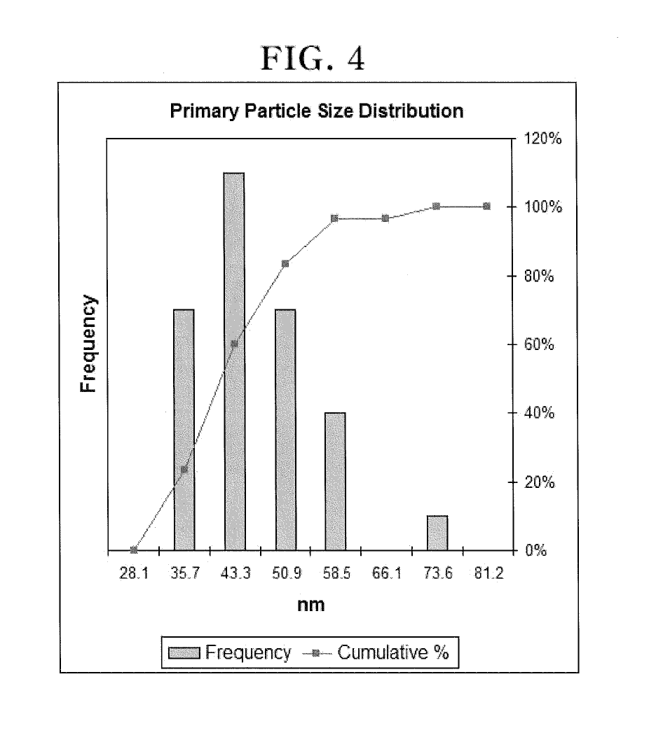

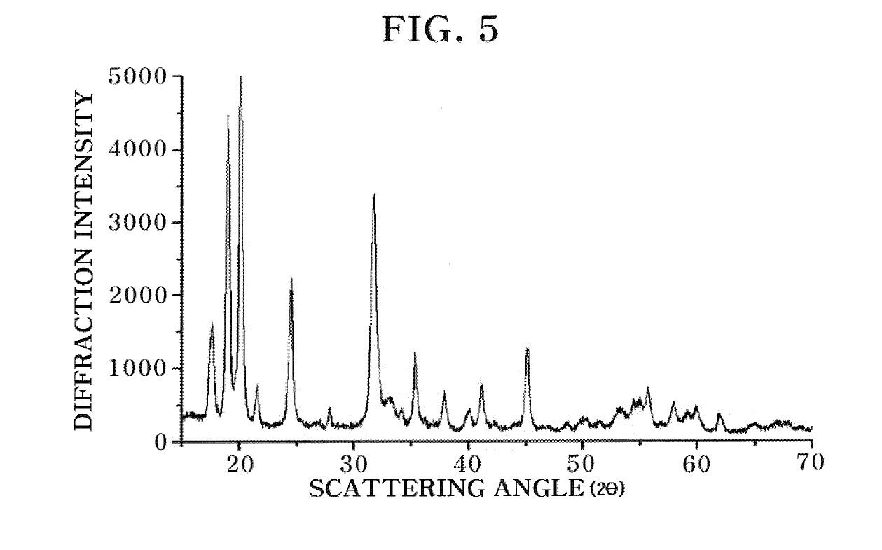

After drying the centrifugated cake for 16 hours at 70° C., 146 g of a dried powder was obtained. FIG. 3 illustrates an SEM image of iron phosphate particles prepared according to the present Example, by which it can be confirmed that the prepared particles are uniform nanoparticles. FIG. 4 illustrates a particle size distribution of the iron phosphate particles prepared according to the present Example, by which it can be confirmed that this is consistent with the steepness ratio (D75/D25) of 1.35. FIG. 5 illustrates XRD patterns of the nano-sized iron phosphate particles prepared according to the present Example, by which it can be confirmed that this is consistent with the literature data indicating the meta-strengite I phase. As a result of elemental analysis, according to Inductively Coupled Plasma-Optical Emission Spectroscopy (ICP-OES), Fe=28.5 wt %, and P=17.5 wt %, and according to Ion Chromatography (IC) (detection limit=50 ppm), Cl⁻ was not detected.

### EXAMPLE 3

### Synthesis of Crystalline Iron(III) Phosphate (Ferric Phosphate) (FePO₄.2H₂O)

The ferric phosphate particles were prepared in the same manner as in Example 2, except that 6.36 g of phosphoric acid (H₃PO₄) having a concentration of 85% was added to the yellow suspension and the mixture was heat-treated for 90 min at 80° C. The resulting ferric phosphate particles had an average particle size of 28.7 nm and a steepness ratio of 1.47. According to XRD diffraction patterns, it can be confirmed that the ferric phosphate was formed by crystallizing in the meta-strengite I phase.

### EXAMPLE 4

### Synthesis of Crystalline Iron(III) Phosphate (Ferric Phosphate) (FePO₄.2H₂O)

The crystalline ferric phosphate particles were prepared in the same manner as in Example 1, except that 75 ml of a diammonium phosphate (NH₄)₂HPO₄ solution having a concentration of 0.32 mol/l and 8375 g of an ammonium hydroxide solution (5.82 wt % as NH₃) were premixed, filtered, and stored in the tank 118. The resulting ferric phosphate particles had an average particle size of 33.4 nm and a steepness ratio of 1.39. According to XRD diffraction patterns, it can be confirmed that the ferric phosphate was formed by crystallizing in the meta-strengite I phase.

### EXAMPLE 5

### Synthesis of Crystalline Iron(III) Phosphate (Ferric Phosphate) (FePO₄.2H₂O)

The crystalline ferric phosphate particles were prepared in the same manner as in Example 1, except that 75 ml of a phosphoric acid (H₃PO₄) solution having a concentration of 3 wt % and 7.7 g of an ammonium hydroxide solution (25 wt % of NH₃) were premixed, filtered, and stored in the tank 118.

The resulting ferric phosphate particles had an average particle size of 38.7 nm and a steepness ratio of 1.42. By means of XRD diffraction patterns, it can be confirmed that the ferric phosphate was formed by crystallizing in a meta-strengite I phase.

### EXAMPLE 6

### Synthesis of Crystalline Iron(III) Phosphate (Ferric Phosphate) (FePO₄.2H₂O)

The crystalline ferric phosphate particles were prepared in the same manner as in Example 1, except that bubbling of ammonia gas was conducted on 75 ml of a phosphoric acid (H₃PO₄) solution having a concentration of 3 wt % to prepare the mixed solution having a pH of 9.87. The resulting ferric phosphate particles had an average particle size of 35.9 nm and a steepness ratio of 1.46. According to XRD diffraction patterns, it can be confirmed that the ferric phosphate was formed by crystallizing in the meta-strengite I phase.

### EXAMPLE 7

### Synthesis of Iron(II) Phosphate (Ferrous Phosphate Hydrate) (Fe₃(PO₄)₂.8H₂O)

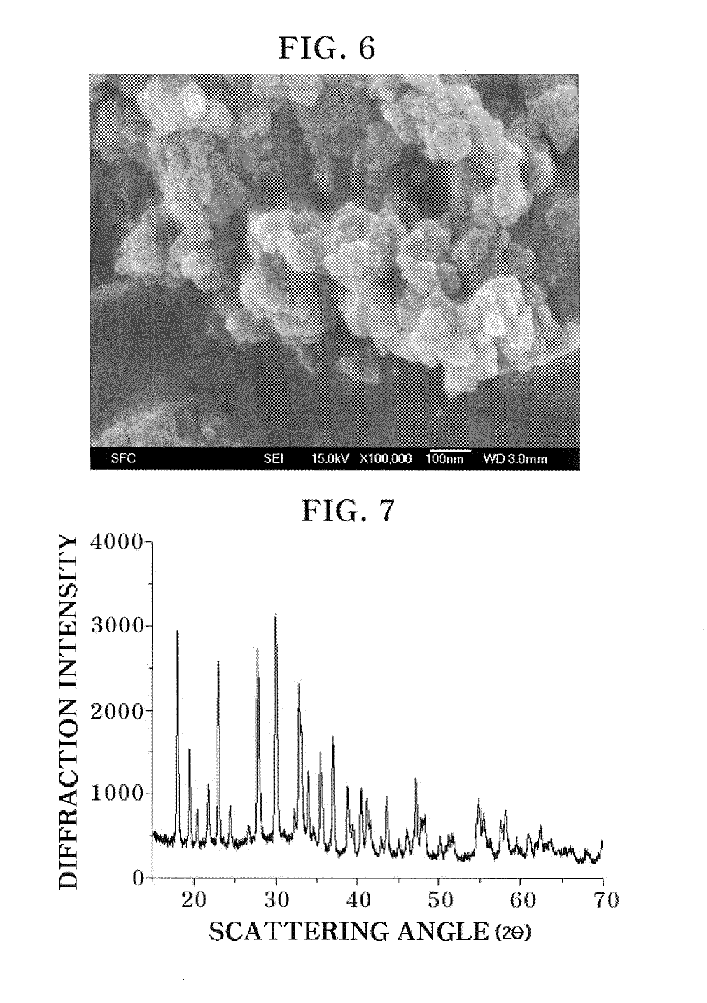

An aqueous solution of iron sulfate (FeSO₄.7H₂O) was put into the iron salt tank 113 and an aqueous solution of sodium phosphate (Na₃PO₄.12H₂O) was put into the tank 118, which was then stirred. At this time, the molar ratio of the raw materials was [Fe]:[P]=3:2 and the ratio of the solid content to the solvent was 20%. The above solutions were injected the at the same time into the reactor 101A to which nitrogen gas was being injected at 5 l/min at a pump speed of 0.4 l/min and an injection speed of 5 m/s. The temperatures of the tanks and the reactor were room temperature (25° C.). At this time, the high gravity level of the packed bed 102 was 1579 m/s², and the residence time in the molecular level mixing unit 100 was set to 20 s. Subsequently, after setting the temperature of the reactor to 70° C., it was additionally operated for 15 min. The resulting reaction slurry was washed 3 times using a pressure-reducing filter. The washed cake was dried in an oven at 90° C. to synthesize iron(II) phosphate. FIG. 6 illustrates an SEM image of iron(II) phosphate synthesized according to the present Example, by which it can be confirmed that the synthesized particles are uniform nanoparticles. FIG. 7 illustrates XRD diffraction patterns of iron(II) phosphate synthesized according to the present Example. Referring to FIG. 7, it can be confirmed that the ferrous phosphate was formed by crystallizing in a vivianite phase.

### EXAMPLE 8

### Synthesis of Iron(II) Phosphate (Ferrous Phosphate Hydrate) (Fe₃(PO)₂.8H₂O)

An aqueous solution of iron sulfate (FeSO₄.7H₂O) was put into the iron salt tank 113 and an aqueous solution of diammonium phosphate (NH₄)₂HPO₄ was put into the tank 118, which was then stirred. At this time, the molar ratio of the raw materials was [Fe]:[P]=3:2 and the ratio of the solid content to the solvent was 20%. The above solutions were injected at the same time into the reactor 101A to which nitrogen gas was being injected at 5 l/min at a pump speed of 0.4 l/min and an injection speed of 5 m/s. The temperatures of the tanks and the reactor were room temperature (25° C.). At this time, the high gravity level of the packed bed 102 was 1579 m/s², and the residence time in the molecular level mixing unit 100 was set to 20 s. After the end of the injection of the raw materials, 5 ml of a 10 wt % sodium hydroxide (NaOH) aqueous solution was added such that the pH was 7 or higher. Subsequently, after setting the temperature of the reactor to 70° C., it was additionally operated for 15 min. The resulting reaction slurry was washed 3 times using a pressure-reducing filter. The washed cake was dried in an oven at 90° C. to synthesize iron(II) phosphate. According to XRD diffraction patterns, it can be confirmed that the ferrous phosphate was formed by crystallizing in the vivianite phase.

### EXAMPLE 9

### Synthesis of Iron(II) Phosphate (Ferrous Phosphate Hydrate) (Fe₃(PO₄)₂.8H₂O)

An aqueous solution of ferrous ammonium sulfate (Fe(NH₄)₂(SO₄)₂.7H₂O) was put into the iron salt tank 113 and an aqueous solution of dipotassium phosphate (K₂HPO₄) was put into the tank 118, which was then stirred. At this time, the molar ratio of the raw materials was [Fe]:[P]=3:2 and the ratio of the solid content to the solvent was 25%. The above solutions were injected at the same time into the reactor 101A to which nitrogen gas was being injected at 5 l/min at a pump speed of 0.4 l/min and an injection speed of 5 m/s. The temperatures of the tanks and the reactor were room temperature (25° C.). At this time, the high gravity level of the packed bed 102 was 1579 m/s², and the residence time in the molecular level mixing unit 100 was set to 20 s. After the end of the injection of the raw materials, a saturated ammonium hydroxide (NH₄OH) aqueous solution was added such that the pH was 6.5. Subsequently, after setting the temperature of the reactor to 70° C., it was additionally operated for 15 min. The resulting reaction slurry was washed 3 times using a pressure-reducing filter. The washed cake was dried in an oven at 90° C. to synthesize iron(II) phosphate. According to XRD diffraction patterns, it can be confirmed that the ferrous phosphate was formed by crystallizing in the vivianite phase.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof. The present invention is not limited by the above embodiments and the accompanying drawings, but is intended to be limited only by the appended claims. Therefore, various forms of substitutions, modifications and changes which do not depart from the spirit and scope of the invention which is limited only by the claims will be possible by those skilled in the art, and all such substitutions, modifications and changes are also deemed to be covered by the invention.

1. A method for preparing nano-sized iron phosphate particles, the method comprising the steps of:
mixing an iron salt solution and a phosphate solution in a reactor in order to form a suspension containing amorphous or crystalline iron phosphate precipitates; and
applying a shearing force to the mixed solution inside the reactor during the step of mixing,
wherein the suspension containing nano-sized iron phosphate precipitate particles is formed by controlling the shearing force and the conditions inside the reactor.

2. The method for preparing nano-sized iron phosphate particles of claim 1, further comprising:
a step of isolating the iron phosphate precipitate particles from the suspension.

3. The method for preparing nano-sized iron phosphate particles of claim 1, further comprising:
a step of aging the nano-sized iron phosphate precipitate particles.

4. The method for preparing nano-sized iron phosphate particles of claim 3, wherein the step of aging is carried out under conditions in which crystalline nano-sized iron phosphate precipitate particles are formed.

5. The method for preparing nano-sized iron phosphate particles of claim 1, wherein the iron salt solution comprises one or more selected from the group consisting of an iron acetate salt, an iron halide salt, an iron nitrate salt, an iron sulfate salt, an iron hydroxide, and a hydrate and a mixture thereof.

6. The method for preparing nano-sized iron phosphate particles of claim 1, further comprising:
a step of selecting the phosphate solution as a precipitation solution.

7. The method for preparing nano-sized iron phosphate particles of claim 6, wherein the phosphate solution comprises PO₄³⁻.

8. The method for preparing nano-sized iron phosphate particles of claim 1, wherein the step of applying the shearing force comprises stirring the mixed solution with a stirrer.

9. The method for preparing nano-sized iron phosphate particles of claim 8, wherein the stirrer comprises a packed bed located inside a sealed chamber and the packed bed is rotated about a rotation axis.

10. The method for preparing nano-sized iron phosphate particles of claim 9, wherein the packed bed has a cylindrical form, and comprises at least one mesh layer.

11. The method for preparing nano-sized iron phosphate particles of claim 1, wherein flow conditions in which a Reynolds number is 2,000 to 200,000 are formed inside the reactor by means of the shearing force.

12. The method for preparing nano-sized iron phosphate particles of claim 1, wherein the nano-sized iron phosphate precipitate particles have a narrow particle size distribution of which a steepness ratio is smaller than 3.

13. The method for preparing nano-sized iron phosphate particles of claim 1, wherein the mixed solution further comprises a surfactant.

14. The method for preparing nano-sized iron phosphate particles of claim 13, wherein the surfactant comprises one or more selected from the group consisting of an anionic surfactant, a cationic surfactant, a nonionic surfactant, a polymer surfactant, and a mixture thereof.

15. The method for preparing nano-sized iron phosphate particles of claim 13, wherein a concentration of the surfactant is 0.05 to 10 wt % based on the mixture.

16. The method for preparing nano-sized iron phosphate particles of claim 1, wherein the mixed solution further comprises a dispersant.

17. The method for preparing nano-sized iron phosphate particles of claim 16, wherein a concentration of the dispersant is 0.05 to 10 wt % based on the mixture.

18. The method for preparing nano-sized iron phosphate particles of claim 1, wherein the nano-sized iron phosphate precipitate particles are amorphous.

19. The method for preparing nano-sized iron phosphate particles of claim 18, further comprising:
a step of aging the suspension under conditions in which crystalline iron phosphate particles are formed.

20. The method for preparing nano-sized iron phosphate particles of claim 1, wherein the step of mixing is carried out under conditions in which the precipitates mainly containing an iron phosphate are formed.

21. The method for preparing nano-sized iron phosphate particles of claim 20, wherein the conditions are conditions under which intermediate iron phosphate species are not formed.

22. The method for preparing nano-sized iron phosphate particles of claim 1, wherein the shearing force is applied under conditions in which at least one of nano-sized amorphous iron phosphate particles and crystalline iron phosphate particles is formed.

23. A method for preparing nano-sized iron phosphate particles, the method comprising the steps of:
mixing an iron salt solution and a phosphate solution under conditions in which nano-sized amorphous iron phosphate particles are formed; and
aging the nano-sized amorphous iron phosphate particles under conditions in which nano-sized crystalline iron phosphate particles are substantially formed.

24. A method for preparing nano-sized iron phosphate particles, the method comprising the steps of:
mixing an iron salt solution and a phosphate solution in a reactor under conditions in which nano-sized amorphous iron phosphate particles are formed;
applying a shearing force to the mixed solution inside the reactor during the step of mixing, and controlling the shearing force and the conditions inside the reactor to form nano-sized amorphous iron phosphate particles; and
aging the nano-sized amorphous iron phosphate particles under conditions in which nano-sized iron phosphate particles are formed.

25. The method for preparing nano-sized iron phosphate particles of claim 24, further comprising:
a step of applying a shearing force to a mixture containing nano-sized amorphous iron phosphate particles during the step of aging, and controlling the shearing force and the conditions in the mixture to form the nano-sized crystalline iron phosphate particles.

26. A method for preparing nano-sized iron phosphate particles, the method comprising the steps of:
mixing an iron salt solution and a phosphate solution in a reactor under conditions in which a mixture containing nano-sized amorphous iron phosphate particles is formed;
applying a shearing force to the mixed solution inside the reactor during the step of mixing, and controlling the shearing force and the conditions inside the reactor to form nano-sized amorphous iron phosphate particles;
isolating the nano-sized amorphous iron phosphate particles from the mixture containing the nano-sized amorphous iron phosphate particles;
aging the nano-sized amorphous iron phosphate particles under conditions in which a mixture containing nano-sized iron phosphate particles is formed;
applying a shearing force to the mixture containing the nano-sized amorphous iron phosphate particles during the step of aging, and controlling the shearing force and the conditions inside the mixture to form nano-sized crystalline iron phosphate particles;
isolating the nano-sized crystalline iron phosphate particles from the mixture containing the nano-sized crystalline iron phosphate particles; and
drying the nano-sized crystalline iron phosphate particles in order to form a crystalline iron phosphate powder.

27. The method for preparing nano-sized iron phosphate particles of claim 1, wherein the iron salt solution comprises one or more selected from the group consisting of an iron(III) acetate salt, an iron(III) halide salt, an iron(III) nitrate salt, an iron(III) sulfate salt, and a hydrate and a mixture thereof.

28. The method for preparing nano-sized iron phosphate particles of claim 1, wherein the formed iron phosphate precipitate particles comprise a ferric phosphate.

29. The method for preparing nano-sized iron phosphate particles of claim 28, wherein the ferric phosphate comprises one or more selected from the group consisting of an amorphous ferric phosphate, a crystalline ferric phosphate, and a hydrate and a mixture thereof.

30. The method for preparing nano-sized iron phosphate particles of claim 1, wherein the iron salt solution comprises one or more selected from the group consisting of an iron(II) acetate salt, an iron(II) halide salt, an iron(II) nitrate salt, an iron(II) sulfate salt, an iron(II) hydroxide, and a hydrate and a mixture thereof.

31. The method for preparing nano-sized iron phosphate particles of claim 1, wherein the formed iron phosphate precipitate particles comprise a ferrous phosphate.

32. The method for preparing nano-sized iron phosphate particles of claim 31, wherein the ferrous phosphate comprises one or more selected from the group consisting of an amorphous ferrous phosphate, a crystalline ferrous phosphate, and a hydrate and a mixture thereof.
